(19) United States
(12) Patent Application Publication
(10) Pub. No.: US 2008/0049617 A1
(43) Pub. Date: Feb. 28, 2008

(54) SYSTEM FOR FINE GRAINED FLOW-CONTROL CONCURRENCY TO PREVENT EXCESSIVE PACKET LOSS

(75) Inventors: Donald G. Grice, Gardiner, NY (US); Kalyan C. Gunda, Wappingers Falls, NY (US); Brian D. Herr, Rhinebeck, NY (US); Gautam H. Shah, Shrewsbury, MA (US)

Correspondence Address: CANTOR COLBURN LLP-IBM POUGHKEEPSIE, 20 Church Street, 22nd Floor, Hartford, CT, 06103, US

(73) Assignee: International Business Machines Corporation, Armonk, NY (US)

(21) Appl. No.: 11/466,615

(22) Filed: Aug. 23, 2006

(51) Int. Cl. H04J 1/16

(52) U.S. Cl. 370/235; 370/252

(57) ABSTRACT

A system for flow-control concurrency to prevent excessive packet loss, including at least one transmitter node. Each transmitter node is configured to transmit data. A first flow-control device is coupled to the at least one transmitter node. The first flow-control device is configured to limit the number of concurrent data replies sent by the at least one transmitter node such that the resources on the transmitter node side will not be overrun. At least one receive node is configured to receive data transmitted. The at least one receiver node is coupled to the at least one transmitter node via the communication network. A second flow-control device is coupled to the at least one receiver node. The second flow-control device is configured to limit the number of concurrent data requests received by the at least one receiver node such that the resources on the receiver node side will not be overrun.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of Invention

This invention relates in general to data transmission, and more particularly, to controlling the rate of data flow from one source to another source.

2. Description of Background

Communication protocols used to transmit data over a network typically break the data down into smaller packets that are transmitted and re-assembled at a receiver. Flow control is required to pace the data so that the receiving device can handle the incoming data. Flow control attempts to prevent resources at either a sender device or the receiver node from being over-run, which leads to packet loss and retransmissions as well as degraded performance.

Standard methods generally involve some variation of a request/reply mechanism where the sender device transmits a request to send data and waits for a reply from the receiver node specifying how much data may be sent. These standard solutions work well for point-to-point connections, but are deficient when the receiver node receives data from various sender devices or the sender device transmits to various receiver nodes. In the multi-node case, the receiver's/sender's resources are easily overrun causing performance degradation due to excessive packet drops.

Thus, there is a need for a system that implements fine-grained flow control concurrency to prevent excessive packet loss when the receiver node receives data from various sender devices or the sender device transmits to various receiver nodes.

### SUMMARY OF THE INVENTION

The shortcomings of the prior art are overcome and additional advantages are provided through the provision of a system for flow-control concurrently to prevent excessive packet loss. The system includes at least one transmitter node. Each transmitter node is configured to transmit data. A first flow-control device is communicatively coupled to the least one transmitter node via a communication network. The first flow-control device is configured to limit the number of concurrent data replies sent by the at least one transmitter node such that the resources on the transmitter node side will not be overrun and such that no congestion occurs in the network. The system further includes at least one receiver node. Each receiver node is configured to receive data transferred by the at least one transmitter node. The at least one receiver node being communicatively coupled to the at least one transmitter node via the communication network. A second flow-control device is communicatively coupled to the at least one receiver node via the communication network. The second flow-control device is configured to limit the number of concurrent data requests received by the at least one receiver node such that the resources on the receiver node side will not be overrun and such that no congestion occurs in the network.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution for a system for flow-control concurrency to prevent excessive packet loss.

### BRIEF DESCRIPTION OF THE DRAWINGS

The subject matter regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a system for flow-control concurrency to prevent excessive packet loss, in accordance with the disclosed invention; and

FIG. 2 illustrates one example of a method for a fine grained concurrency parameter of the system in FIG. 1;

FIG. 3 illustrates one example of a method for an alternative fine grained concurrency parameter of the system in FIG. 1; and

FIG. 4 illustrates one example of a method for an alternative fine grained concurrently parameter of the system in FIG. 1.

The detailed description explains an exemplary embodiment of the invention, together with advantages and features, by way of example with reference to the drawings.

### DETAILED DESCRIPTION OF THE INVENTION

Figure illustrates a portion of computing network including a plurality of nodes. Only two nodes are shown for ease of illustration, but it is understood that the computing network includes numerous nodes, which can transmit data to multiple nodes and receive data from multiple nodes. For simplicity, node 20 is referenced as a transmitter node 20 and node 40 is referenced as receiver node 40, although it is understood that all nodes may both send and receive data. Nodes 20 and 40 are processor-based devices and execute computer programs to perform the processes described herein.

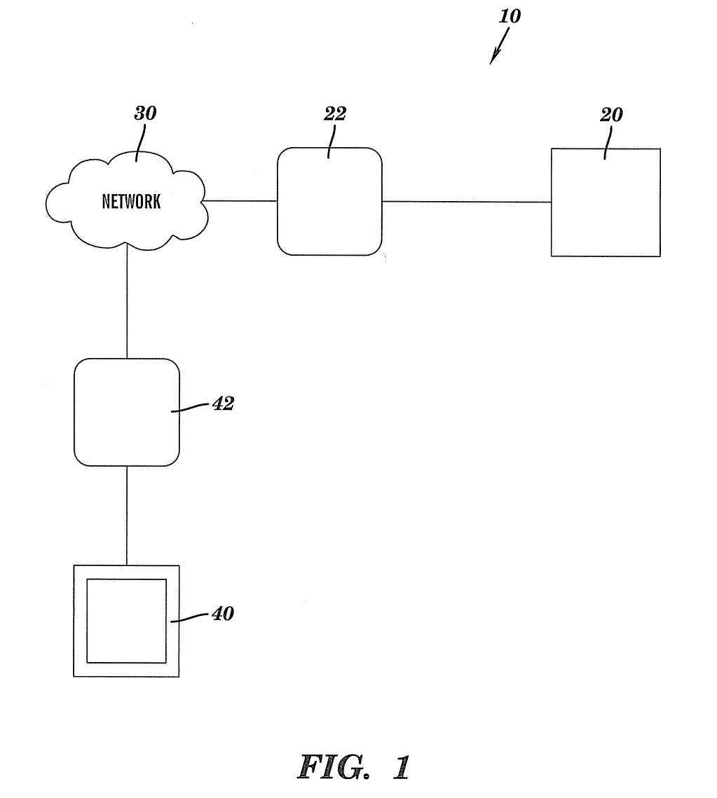

Referring to FIG. 1, a system for flow-control concurrency to prevent excessive packet loss is shown. At least one transmitter node 20 is included with the system 10. Each transmitter node 20 is configured to transmit data. A first flow-control device 22 is communicatively coupled to the at least one transmitter node 20. The first flow-control device 22 may be implemented through a software application executing on node 20. The first flow-control device 22 is configured to limit the number of concurrent data replies that are sent by the at least one transmitter node 20. This ensures that the resources on the sending side will not be over-run.

The system further includes at least one receiver node 40. Each receiver node 40 is configured to receive data transferred by the at least one transmitter node 20. Each receiver node 40 is communicatively coupled to the at least one transmitter node 20 via the communication network 30. A second flow-control device 42 is communicatively coupled to the at least one receiver node 40. The second flow-control device 42 may be implemented through a software application executing on node 40. The second flow-control device 42 is configured to limit the number of concurrent data requests received by the at least one receiver node 40. This ensures that resources on the receiving side will not be over-run.

Prior to the transmission of data for a write request, each transmitting node 20 transmits a request to send data to the at least one receiving node 40. The at least one receiving node 40 is configured to receive the data transmitted by the at least one transmitting node 20. The at least one receiving node 40 is further configured to accept the request to send data and to transmit a reply to the at least one transmitting node 20 that pertains to the request to send data that was transmitted by the at least one transmitter node 20. The second flow-control device 42 is configured to limit the number of concurrent replies to send data. This ensures that the resources on the receiving side will not be overrun.

The first flow-control and the second flow-control device 22 and 42, respectively, are configured to adhere to fine grained concurrently parameters that are part of the subsystem configuration commands. These parameters include (i) maximum read count, (ii) maximum read response count, and (iii) maximum write count.

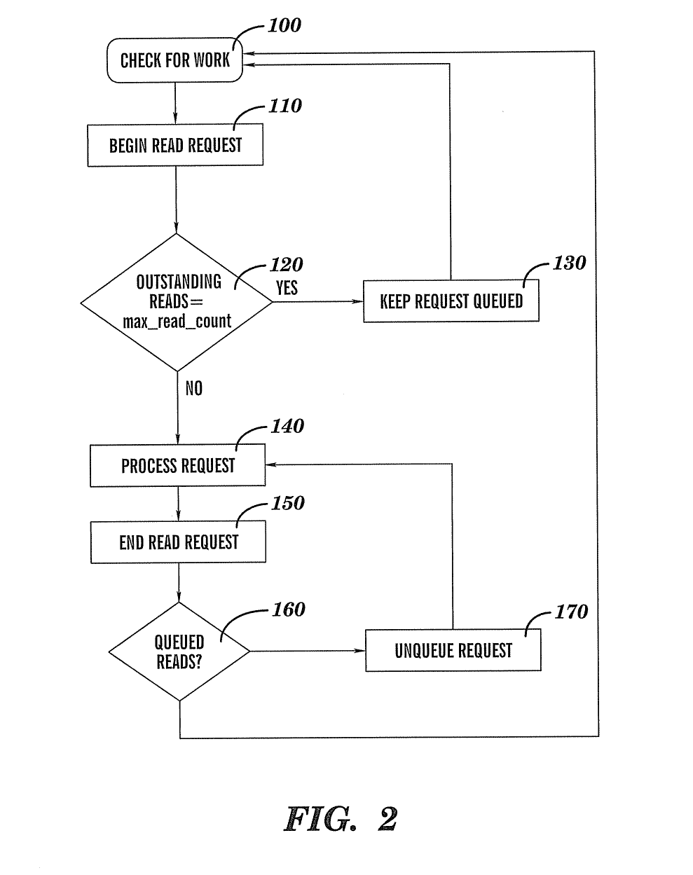

Referring to FIG. 2, a method pertaining to the usage of the fine-grained concurrency parameter of maximum read count is shown. Maximum read count specified the number of concurrent outstanding reads that are permitted at a client node (receiver node). This provides the ability to limit the amount of data being received by a client node in order to prevent resource overruns. As read requests come into a node, provided the number of outstanding reads is less that the maximum read count they are immediately processed. If the number of outstanding reads is equal or greater than the maximum read count, then the read remains queued for later processing. Stepwise, starting at step 100 a check for work is performed. At step 110 a read request is began. At step 120 the quantity of the outstanding reads is compared to the maximum read count. If the quantity of the outstanding reads is equal to or greater than the maximum read count, the read request is queued at step 130. Otherwise, the request is processed at step 140. At step 150, the read request is terminated. At step 160 reads are checked, if the read is queued at step 170 the request is unqueued, otherwise the method starts over again at step 100.

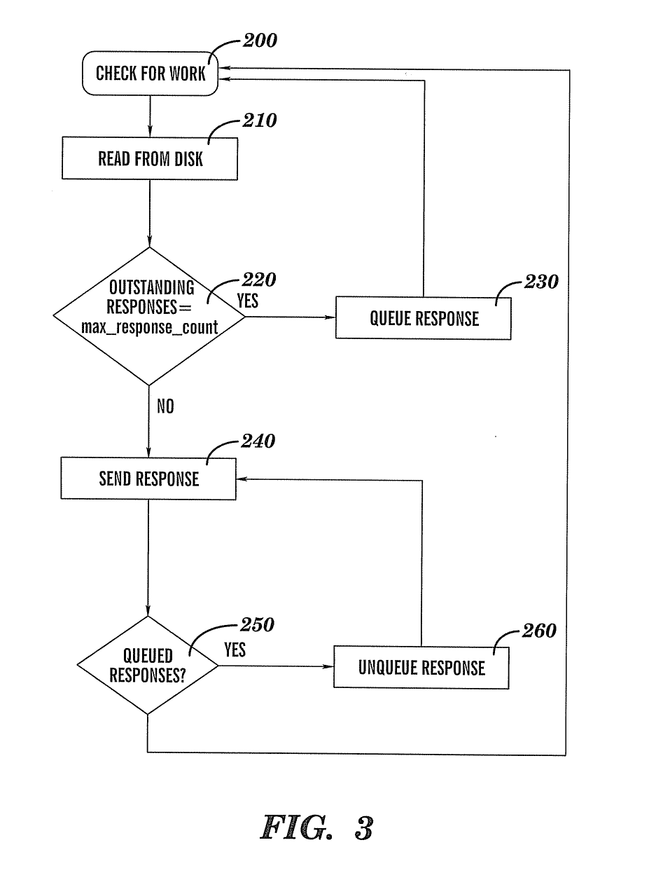

Referring to FIG. 3, a method pertaining to the usage of the fine grained concurrency parameter of maximum read response count is shown. Maximum read response count specifies the number of concurrent outstanding read responses that are permitted at a transmitter node. This provides a mechanism to limit the amount of data being sent by a transmitter node in order to prevent resource overruns. On a read request, the transmitter node will read the data from the disk and then check the number of outstanding read responses. If the number of outstanding read responses is less than the maximum read response count, then immediately send the data to the client node (receiver). Otherwise, queue the request for later processing. Stepwise, starting at step 200, a check for work is performed. Then at step 210, the disk is read. At step 220 the outstanding responses are checked. If the outstanding responses are equal to the maximum response count, the response is queued at step 230. Otherwise the response is dispatched at step 240. At step 250 the responses are checked, if the responses are queued then at step 260 the response shall be unqueued, otherwise the method starts over again at step 200.

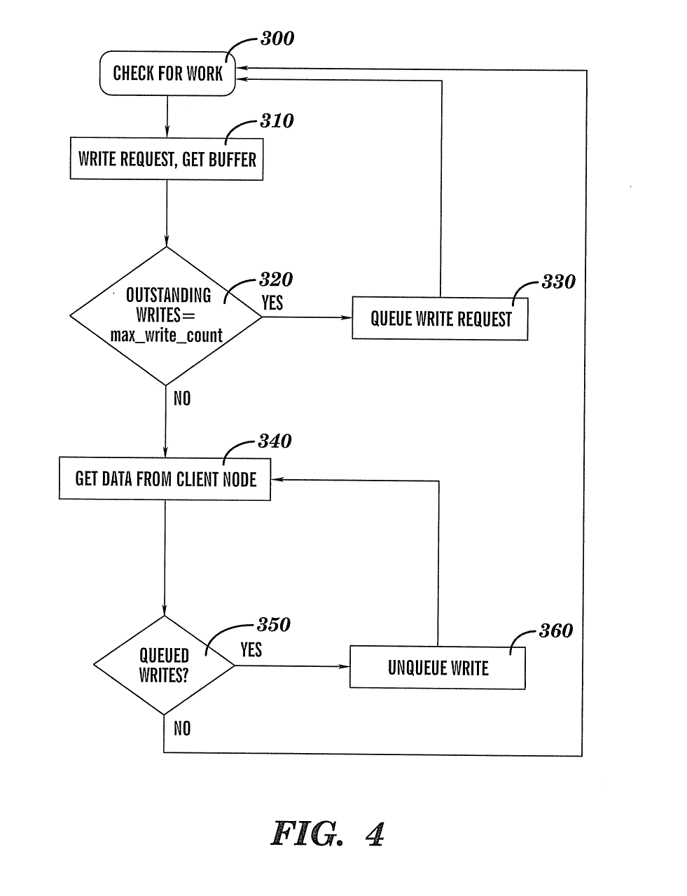

Referring to FIG. 4, a method pertaining to the usage of the fine-grained concurrency parameter of maximum write count flow is shown. On a write request, the receiver node will allocate buffers and check the number of outstanding write requests. If the number of outstanding write requests is less than the maximum write count, then immediately send a signal to the client node requesting the data. Otherwise, queue the request for later processing. Stepwise, starting at step 300 a check for work is performed. At step 310 a write request is performed. At step 320 a check of the outstanding writes is performed. If the outstanding write equals the maximum write count the write request is queued at step 330. Otherwise, data is acquired from the client node at step 340. Subsequently, at step 350 the writes are checked. If the check discloses that the writes are queued, at step 360 the writes shall be unqueued. Otherwise the method starts over again at step 300.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system for flow-control concurrency to prevent excessive packet loss, comprising:
at least one transmitter node, each transmitter node configured to transmit data;
a first flow-control device communicatively coupled to the at least one transmitter node via a communication network, the first flow-control device configured to limit the number of concurrent data replies sent by the at least one transmitter node such that the resources on the transmitting node side will not be overrun and such that no congestion occurs in the network;
at least one receiver node, each receiver node configured to receive data transferred by the at least one transmitter node, the at least one receiver node being communicatively coupled to the at least one transmitter node via the communication network; and
a second flow-control device communicatively coupled to the at least one receiver node, the second flow-control device configured to limit the number of concurrent data requests received by the at least one receiver node such that the resources on the receiver node side will not be overrun and such that no congestion occurs in the network.

2. The system of claim 1, wherein the transmitter node is configured to transmit a request to send data to the receiving device prior to the transmission of data.

3. The system of claim 2, wherein the receiving node is configured to accept the request to send data transmitted by the transmitter node.

4. The system of claim 3, wherein the receiver node is configured to transmit a reply to the transmitter node that pertains to the request to send data transmitted by the transmitter node.

5. The system of claim 4, wherein the first flow-control device is configured to adhere to fine-grained concurrency parameters added to the subsystem configuration commands.

6. The system of claim 7, wherein the second flow-control device is configured to adhere to fine-grained concurrency parameters added to the subsystem configuration commands.

7. The system of claim 6, wherein the fine-grained concurrency parameters include (i) maximum read count, (ii) maximum read response count, and (iii) maximum write count.
